(19) United States
(12) Patent Application Publication
(10) Pub. No.: US 2026/0193012 A1
(43) Pub. Date: Jul. 9, 2026

(54) SELF-CONTAINED HOT MEAL ASSEMBLY WITH STEAM VENT

(71) Applicant: Saul Mishkin, Pembroke Park, FL (US)

(72) Inventor: Saul Mishkin, Pembroke Park, FL (US)

(21) Appl. No.: 19/445,279

(22) Filed: Jan. 9, 2026

Related U.S. Application Data
(63) Continuation-in-part of application No. 18/203,529, filed on May 30, 2023, now abandoned.
Application No. 18/203,529 is a continuation-in-part of application No. 15/188,053, filed on Jun. 21, 2016, now Pat. No. 11,661,261.
(60) Provisional application No. 62/296,815, filed on Feb. 18, 2016.

(51) Int. Cl. B65D 81/34; A47J 36/28; B65D 75/00; B65D 77/04

(52) U.S. Cl. CPC B65D 81/3484; A47J 36/28; B65D 75/008; B65D 77/04; B65D 2205/02

(57) ABSTRACT

A self-contained meal assembly comprises a heating bag, a food pouch, and a nonflammable aqueous liquid activated heating element providing a high-efficiency reduced-mass exothermic heating system. A directional, multi-path steam vent system allows steam to circulate the interior of the heating bag during operation and discharge from the heating bag to provide more efficient and uniform heating of food products contained in the food pouch.

### BACKGROUND OF THE INVENTION

### Claim of Priority

The present application is a Continuation-In-Part (CIP) patent application of and claims priority to a previously filed, Continuation-In-Part (CIP) patent application, namely, that having Ser. No. 18/203,529 and a filing date of May 30, 2023, and further, claims priority to a previously filed, U.S. Non-Provisional patent application, namely, that having Ser. No. 15/188,053 and a filing date of Jun. 21, 2016, which has matured into U.S. Pat. No. 11,661,261 issued on May 30, 2023, and further, claims priority to a previously filed, U.S. Provisional patent application, namely, that having Ser. No. 62/296,815 and a filing date of Feb. 18, 2016, with the contents of all prior applications being incorporated herein by reference in their entireties.

### FIELD OF THE INVENTION

This invention relates to aluminum-based exothermic heaters, portable steam-based cooking systems, and modular meal solutions enabling rehydration, steaming, and cooking of diverse food formats.

### DESCRIPTION OF THE RELATED ART

A “Meal, Ready-to-Eat”, more commonly known as an MRE, is a self-contained, individual field ration originally created by the United States military for its service members engaged in combat or other field operations, where food preparation facilities were not readily available. Being lightweight and self-contained, MREs allow for more food rations to be carried on extended trips. MREs have evolved and improved since their original conception years ago and today have been increasingly adapted for use by people while hiking, camping, or engaging in other outdoor activities, where it may be beneficial or perhaps even necessary to have portable and self-contained food rations.

One notable improvement in the history of MREs was the addition of a flameless ration heater (FRH) in 1990, which involved the use of a water-activated exothermic reaction product that emits heat. This product allowed a service member or a backpacker to enjoy a hot meal in the field or on the trek, by placing the food in proximity to the heating element.

As such, MREs provide significant advantages when compared to freeze dried food alternatives, which still require carrying a supply of potable water and a pot to heat the water in, using either a portable stove, which then must also be carried, or building a campfire onsite, which may not always be convenient or safe.

However, the current design of this heating element in combination with traditional MRE packaging is less than ideal, as the current solution requires the placement of a heating pack on one side of the MRE meal pouch, enclosed by an external paper-based carton. The result of this approach is an unevenly heated meal, and an inefficient exothermic reaction due to the inability of the external carton to preserve and circulate heat or steam. As such, in lower temperature environments, the heating packet and the external carton utilized are insufficient for evenly or properly heating up a meal to the desired temperatures.

Prior art heaters are limited in weight efficiency, steam control, heating uniformity and food compatibility. The present invention provides for improved chemistry of the heater composition, as well as improved venting and thermal performance of the heating and venting system within the heating bag. Additionally, the invention introduces a new modular multi-component meal preparation capability enabling cultural, dietary and nutritional customization.

### SUMMARY OF THE INVENTION

The present invention is generally directed to a self-contained hot meal assembly. As such, initially and in broad terms, a self-contained hot meal assembly of the present invention generally comprises a heating bag having a steam circulation and vent system, at least one food container, a heating element, and, optionally, a utensil packet or bag, and/or combinations thereof. Each of the included elements may be prepackaged in a heating bag which may also serve as an external packaging for the self-contained hot meal assembly.

More particularly, the present invention is directed to a self-contained meal heating assembly that includes a high-efficiency reduced-mass exothermic heater system with enhanced steam management and modular multi-component meal preparation capability. In particular, the heating bag or component includes an aluminum-based exothermic composition that allows for a reduced heater mass of approximately 20 grams that is equal to the performance of prior art 40 gram heater composition formulations. The steam circulation and vent system includes a directional steam vent structure that is configured to circulate steam around the food items contained within the heating bag for more efficient and uniform heating of food within containers that are placed within the heating bag. Unlike prior art exothermic heating pouches, the present invention allows for the ability to heat a variety of food containers including baby bottles, cans, bowls, glass jars, frozen foods, proteins and other sealed foods. Moreover, the high-efficiency reduced-mass exothermic heater system of the present invention allows for steam cooking, boiling capability and reconstituting capabilities, as well as modular meal solutions enabling rehydration, steaming and cooking of the diverse food formats. The exothermic heater system of the present invention improves safety, allows for more uniform heating of food, with lower odor and lower steam.

In operation, the heating element is placed within an interior of a heating bag at a bottom or lower portion thereof. At least one food container is placed within the heating bag either above the heating element, beside the heating element, or otherwise proximal to the heating element. A predetermined amount of water or any other nonflammable aqueous liquid is added to the heating bag, and the heating bag is quickly resealed. An aqueous activated exothermic reaction is created by exposing the heating element to the predetermined amount of water or other nonflammable aqueous liquid, which causes the generation of steam and the generated steam to rise and circulate around the food container. The steam is evacuated from the heating bag at a slow and controlled rate via one or more steam vents disposed on a distal and/or upper portion of the heating bag.

The heating bag may comprise a resealable access opening to allow removal of various components from the heating bag, and to allow closure of the heating bag during operation, i.e., while heating one or more food containers therein. The resealable access opening may comprise one or more resealable strip(s) such as a press-and-seal zipper. At least one steam vent is formed along a portion of the heating bag, such as a distal and/or upper portion thereof, and/or at a distal and/or upper corner of the heating bag in order to facilitate the controlled and safe evacuation or release of the steam generated therein away from a user. As such, the steam vent may comprise a substantially circulator aperture imprinted or structured onto the heating bag during construction.

The heating bag may include a single or multilayer film composition designed to be flexible and lightweight, such as to include a base structured and dimensioned to allow the heating bag to stand in a substantially upright position and to provide stability when the product is in operation. An appropriate sealant may be used in its construction having a melting point greater than 120 degrees Celsius and in at least one embodiment greater than 160 degrees Celsius, in order to accommodate for a high efficiency and highly reactive heating element. In at least one embodiment, a heating bag includes a multi-layer construction. In one further embodiment, a water line or visual indicator is printed onto the heating bag along a transparent or partially transparent portion thereof, so that a user can visually determine the predetermined amount of water or other nonflammable aqueous liquid to be added.

A heating element may include any number of chemical composition(s) for generating heat in oxidation-reduction when exposed to water or any other nonflammable aqueous liquid. A heating element may comprise magnesium metal, and may further comprise a mixture of aluminum, calcium oxide, calcium carbonate, calcium di-hydroxide, sodium carbonate, and/or sodium hydroxide for catalyzing and/or accelerating the aqueous exothermic reaction. The heating element may be housed within a fabric pouch or container, which may be formed of a non-woven fabric material, that may or may not be biodegradable. In one further embodiment, a fabric pouch and/or an external surface of a heating element is structured to delay the oxidation reaction, in order to provide the user with sufficient time to reseal the heating bag.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of one illustrative embodiment of a self-contained hot meal assembly of the present invention, including a heating bag, a meal pouch, a heating element, and a utensil packet.

FIG. 2 is a front view of one illustrative embodiment of a self-contained hot meal assembly in accordance with the present invention in operation.

FIG. 3 is a rear view of the illustrative embodiment of a self-contained hot meal assembly of FIG. 2.

FIG. 4 is a schematic representation of one illustrative embodiment of a heating bag in accordance with the present invention having a one-piece construction.

FIG. 5 is a diagrammatic representation of one illustrative embodiment of a method for preparing a hot meal for consumption by a user utilizing a self-contained hot meal assembly in accordance with the present invention.

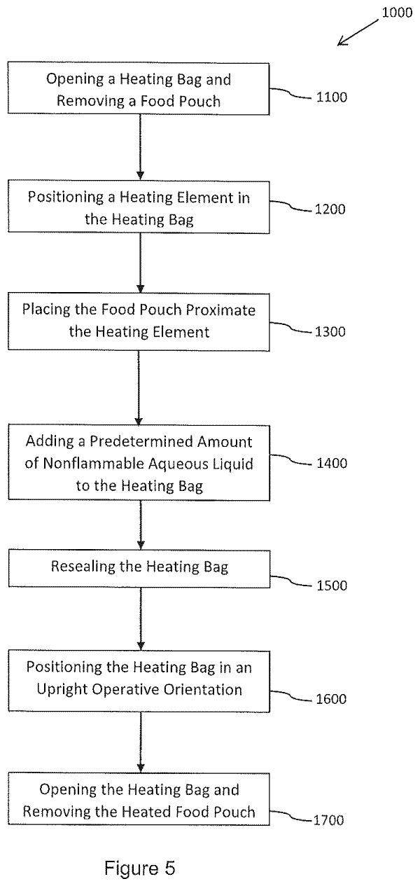

Like reference numerals refer to like parts throughout the several views of the drawings.

### DETAILED DESCRIPTION OF THE PREFERRED EMBODIMENT

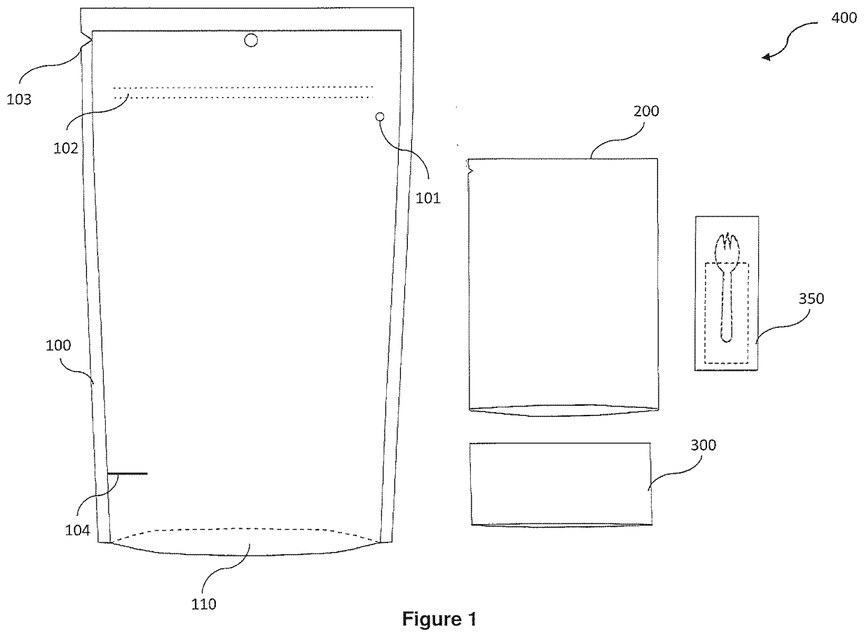

As schematically represented in the accompanying drawings, the present invention is generally directed to a self-contained hot meal assembly 400 as generally illustrated at FIG. 1. Accordingly, the self-contained hot meal assembly 400 comprises a heating bag 100, a food pouch or other food container (e.g., a bottle, can, glass jar, bowl) 200, a heating element 300, a utensil packet 350, and/or combinations thereof. In one embodiment, each of a food pouch 200, a heating element 300, and a utensil packet 350 are prepackaged in a heating bag 100. In at least one further embodiment, a heating bag 100 serves as an outer package for enclosing the various components of a self-contained hot meal assembly 400 in accordance with the present invention. Further, the heating element 300 may be in the form of a heating pad or other structure wherein a reactive composition may be at least partially retained or contained in a manner which facilitates exposure of the reactive composition to water or a nonflammable aqueous liquid, as set forth hereinafter in more detail.

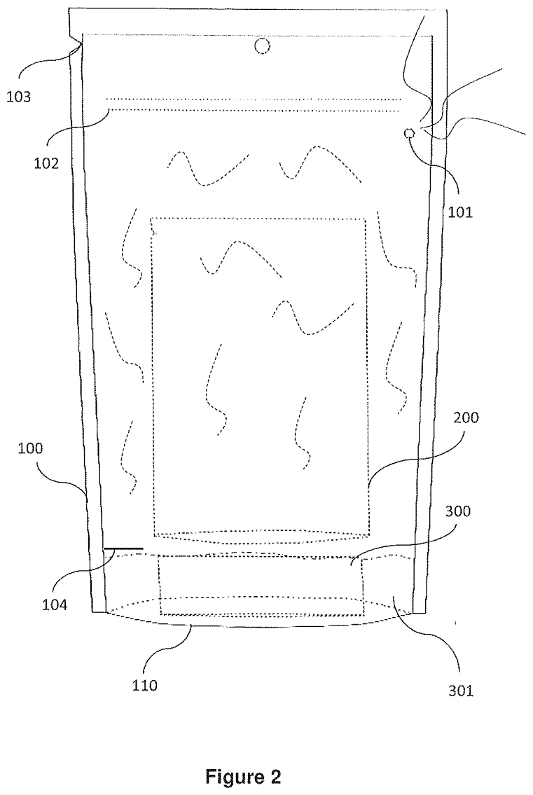

In operation, each of a food pouch 200, a heating element 300, and a utensil packet 350 are removed from an outer package which, as noted above, in at least one embodiment comprises a heating bag 100. Turning to the illustrative embodiment of FIG. 2, a heating element 300 is placed in a lower portion of a heating bag 100. The heating bag 100 includes a base 110 structured and dimensioned to allow the heating bag 100 to stand in a substantially upright position and to provide stability when it is in operation. A food pouch or other food container 200 including an amount of food to be heated is placed within the heating bag 100, once again, either above the heating element 300, beside the heating element 300, or otherwise proximal to the heating element 300. A predetermined amount of water or other nonflammable aqueous liquid is added to the heating bag 100, and the heating bag 100 is quickly resealed. In one embodiment, a predetermined amount of water or other nonflammable aqueous liquid is about three fluid ounces. However, in one or more embodiments the fluid amount added to the heating bag 100 may be between about 2 fluid ounces to 8 fluid ounces. In at least one further embodiment, a water line or visual indicator 104 is printed onto the heating bag 100 along a transparent or partially transparent portion thereof, so that a user can visually determine the predetermined amount of water or other nonflammable aqueous liquid to be added to the heating bag 100. In order to accommodate the above possible variable amount of non-flammable aqueous liquid added to the heating bag 100, the location of the indicator line 104 may vary, dependent on and in cooperation with the location and the size of the heating bag 100, in order to accommodate the addition of between about 2 fluid ounces and about 8 fluid ounces.

An aqueous activated exothermic reaction is initiated by exposing the heating element 300 to the predetermined amount of water or other nonflammable aqueous liquid. The reaction heats the water or nonflammable aqueous liquid, which causes steam to rise and circulate around the food pouch 200. The steam is evacuated from the heating bag 100 at a slow and predetermined controlled rate safely away from the user via at least one steam vent 101 disposed on a distal and/or upper portion of the heating bag 100.

A heating bag 100 in accordance with one embodiment of the present invention comprises a resealable access opening 102, which may include one or more resealable strips for closing the bag to substantially enclose the exothermic steam therein upon operation. In one embodiment, the resealable access opening 102 comprises a plastic zipper as known in the art, such as a press-and-seal zipper. In one other embodiment, the resealable access opening 102 comprises two or more resealable strips. In one embodiment, a zipper closure of the access opening 102 is capable of tolerating temperatures exceeding 250 degrees Fahrenheit. In at least one embodiment, a heating bag may or may not comprise a tear-away notch 103 disposed on an upper portion above a resealable opening 102, such as is shown by way of example in the illustrative embodiment of FIG. 1. A tear-away notch facilitates convenient opening of the heating bag 100 and access to the resealable opening 102. In one embodiment, the upper portion has a reduced width of approximately 19 mm to minimize unused volume, improve pressure retention inside the heating bag 100 and to improve efficiency of steam circulation inside the heating bag 100.

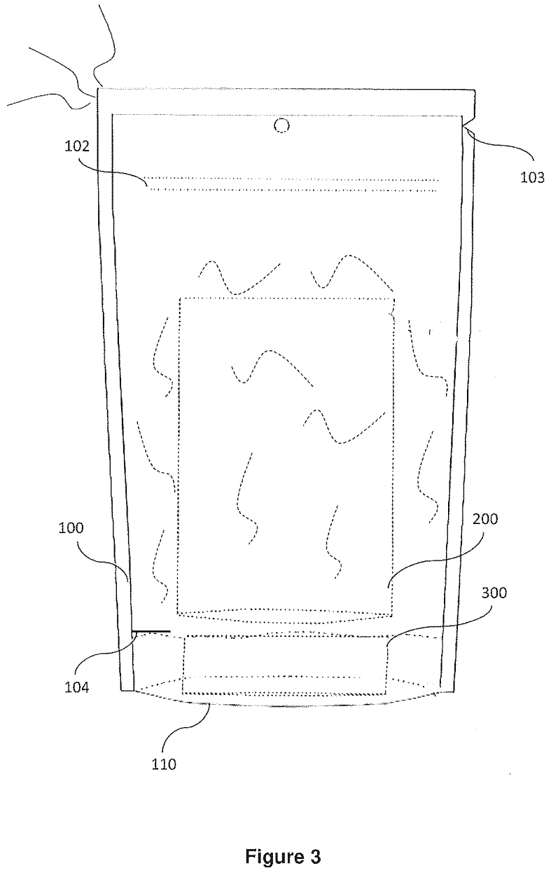

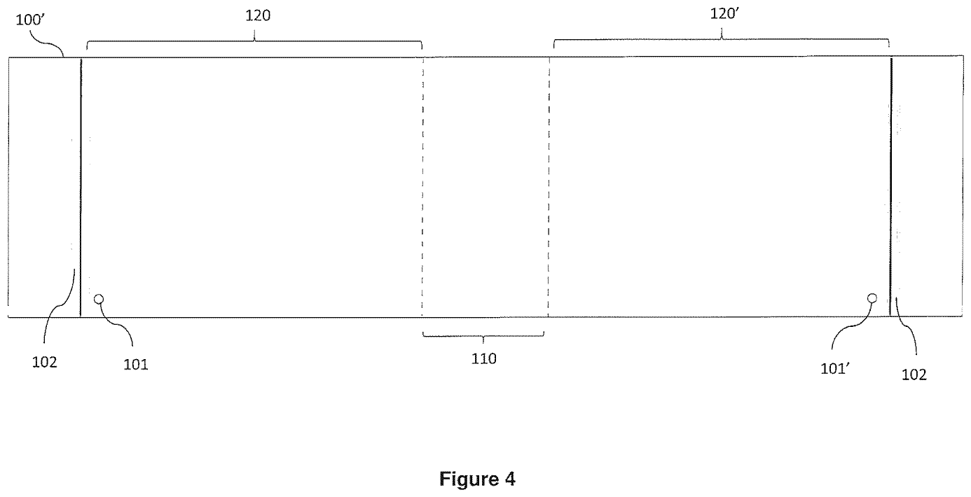

At least one steam vent 101 is formed along an upper portion of the heating bag 100 beneath the resealable access opening 102. As shown in the illustrative embodiment of FIG. 1, the heating vent 101 is disposed through an upper distal corner of the heating bag 100 in order to facilitate the controlled and safe evacuation of steam from therein. In one embodiment, such as is illustrated in FIGS. 2 and 3, a single steam vent 101 is formed on only one side of the heating bag 100, in this embodiment, through an upper distal corner on the front of the heating bag 100. In another embodiment, such as in the illustrative embodiment of FIG. 4, steam vents 101, 101′ are formed through each of the front and back of the heating bag 100′.

A steam vent 101 in accordance with the present invention may comprise a substantially circular aperture formed through a portion of the heating bag 100. Of course, it will be appreciated by those of skill in the art that a steam vent 101 may comprise other geometric configurations which are encompassed within the scope and intent of the present invention. In at least one embodiment, a steam vent 101 is disposed through a distal upper corner of the heating bag 100 and therefore, steam is discharged outwardly from the steam vent at about a 90-degree angle relative to the sides of the heating bag 100, in order to facilitate safe evacuation of the steam away from a user. In other words, the steam vent 101 facilitates the outward projection of steam in a relatively slow and controlled manner and at a predetermined controlled rate. Such a controlled rate or controlled manner of escape allows a sufficient temperature or “threshold temperature” to be maintained within the heating bag 100 by circulating steam evenly around the enclosed food pouch 200, while the steam is being released and while eliminating the danger of over-pressurizing the heating bag 100, causing it to explode or otherwise fail, and potentially harming a user or others proximate the assembly 400, while in use.

In one embodiment, a steam vent comprises a ¼-inch diameter, to allow sufficient heat dissipation, through the escape of steam therethrough, from the heating bag 100 during use, so that the structural integrity of the heating bag 100 is not compromised, while maintaining a sufficient temperature or threshold temperature of the heating process therein to allow for efficient and even heating of an amount of food in a food pouch 200. In one further embodiment, a steam vent 101 comprises a diameter of about ⅛ inch to about ½ inch. In another embodiment, the steam vent is reduced in size to 5 mm. This helps retain more steam pressure inside the heating bag 100, improving heat transfer and overall heating efficiency while maintaining safe pressure relief. As noted above, a steam vent 101 can comprise any of a variety of geometric configurations to facilitate the evacuation of steam from a heating bag 100 at a discharge angle of about 30 degrees to about 90 degrees relative to the sides of the heating bag 100, in order to facilitate safe evacuation of the steam away from a user.

In one embodiment, a visual indicator 104 is marked or otherwise disposed on a heating bag 100, in order to assist a user in adding the predetermined amount of water or other nonflammable aqueous liquid into the heating bag 100 so as to substantially submerge the heating element 300 and initiate an efficient and effective aqueous exothermic reaction. A visual indicator 104 in one embodiment comprises a fill line, and in one further embodiment, a visual indicator 104 comprises an at least partially transparent portion formed on the heating bag 100 itself, such that a user can visualize the amount of water or other nonflammable aqueous liquid being added to the heating bag 100.

In one embodiment, a fluid pouch, not shown, containing a predetermined amount of water or other nonflammable aqueous liquid is incorporated into the present self-contained hot meal assembly 400. A fluid pouch may include a tear-away notch similar to tear-away notch 103 which may be included in the heating bag 100. In another embodiment, a measuring cup, envelope, pouch or other appropriate container (not shown), may be used to allow a user to measure a predetermined amount of water or other nonflammable aqueous liquid, for example, in 3 fluid ounces, or between 2 fluid ounces and 8 fluid ounces, and is incorporated into the present self-contained hot meal assembly 400. In yet one further embodiment, the predetermined amount of water or other nonflammable aqueous liquid to be added to the heating bag 100, once again, by way of example, between 2 fluid ounces and 8 fluid ounces and in certain embodiments 3 fluid ounces, may be printed directly on the heating bag 100 itself.

It is to be noted that in at least one embodiment the amount or quantity of water or nonflammable aqueous liquid added to the heating bag is dependent on the dimensions of the heating element 300 and/or the quantity of reactive composition contained therein or otherwise directly associated therewith. In turn, the amount of reactive composition operatively associated with the heating element 300 may vary in quantity dependent, at least in part, on the dimensions and/or structural features of the heating bag and/or the quantity of food product to be heated. Further, in at least one embodiment, the quantity of reactive composition is about 25 g; at least 25 g or less than 25 g. Further, the adequate amount of water or other nonflammable aqueous liquid may be added to the interior of the heating bag 100 without the inclusion or use of a fluid pouch, measuring cup, etc., such as by adding sufficient amount of water or other non-flammable aqueous liquid to the interior of the heating bag 100 utilizing the indicator line 104, as set forth in detail herein.

As before, a heating bag 100 may comprise a multilayer film composition designed to be flexible, lightweight, and compliant with Food and Drug Administration requirements. However, it is recognized that Food and Drug Administration requirements may not be necessary when the heating bag does not come in contact with the food being heated. An appropriate sealant may be used in the construction of a heating bag 100 having a melting point greater than 120 degrees Celsius, in order to ensure that the heating bag 100 maintains structural integrity at the relatively elevated temperatures created by the heating element 300. A heating bag 100 in accordance with the present invention may be constructed of a number of suitable materials including, but not limited to, polyethylene, polyethylene terephthalate (PET or PETE), high density polyethylene (HDPE), low density polyethylene (LDPE), polypropylene (PP), polystyrene (PS), polyvinyl chloride (PVC), polycarbonate, among other appropriate materials or combinations thereof for implementing the present invention.

A heating bag 100 in accordance with at least one embodiment of the present invention comprises a base 110 structured and dimensioned to allow the heating bag 100 to stand in a substantially upright position while in operation. With reference to FIG. 4, one dimensional embodiment of the present invention is shown. Accordingly, in at least one embodiment, a height 120, 120′ of a heating bag 100 is about 8 inches to about 10 inches, and a width of the base 110 is about 2 inches to about 5 inches. In at least one embodiment, a base 100 comprises a material of construction having sufficient elasticity such that the base 110 is expandable and collapsible. Providing an expandable base 110 allows a volume of a self-contained hot meal assembly 400 to be reduced for transit by user, such as, in a backpack. Different types of food products may require a heating bag 100 having different dimensions in order for the heating process to occur efficiently, However, because it is desirable for steam to travel and/or be disposed inside the heating bag 100, upwards and along one or more external surfaces of a food pouch 200, the height 120, 120′ of a heating bag 100 will be about 1.1 to about 3 times the width of the base 110.

A food pouch 200 may also comprise a single or multi-layer foil pouch with an amount of food sealed therein. In one embodiment, a food pouch 200 comprises a 4-ply layer foil pouch that has undergone a retort process at high temperatures and high pressure for complete sterilization, in order to extend the shelf life of the food therein. In another embodiment, a food pouch comprises between 2 to 8 layers.

Accordingly, structural and/or dimensional modifications of the heating bag 100, heating element 300 and reactive composition have been found to provide different results and operational characteristics. By way of nonlimiting example, a reduction in size of the heating element 300 as well as the size of the non-woven fabric that holds the reactive composition, such as up to 25 gr of mixed chemicals, and reducing the dimensions of the heating element 300 to up to 30% resulted in the ability to heat up to 8-10oz of food in 8-12 minutes reaching and maintaining temperatures above 80° C. for more than 10 minutes. In addition, the heating bag 100 and other types of heating bags constructed with paper and including a hard base can be utilized to contain baby bottles and other food type containers, including cans, etc. It is further contemplated that such structural and/or dimensional modifications of the various components of the self-contained hot meal assembly 400 of the present invention in accord with the inclusion of the basic components as set forth therein provides a versatility which allows for the heating of different types of products such as, but not limited to the hard boiling of eggs, cooking of fish, chicken and other food products. Further modifications as set forth herein as resulted in the processing of freeze-dried food products and reconstituted food and was successful.

A heating element 300 according to one embodiment of the invention has a non-woven pad outer casing that is filled with a reactive composition, and the outer casing having a dual ultrasonic ceiling around its perimeter to provide an enhanced strength, mechanical integrity and better resistance under pressure in elevated temperatures upon activation and heating of the reactive composition contained within the pad casing.

A heating element 300 in accordance with the present invention includes a reactive composition which is reactive upon contact with water or any other nonflammable aqueous liquid for facilitating the generation of heat in an exothermic electron-transfer or oxidation-reduction reaction. In one embodiment, water or another nonflammable aqueous liquid is poured into the heating bag 100 and onto the heating element 300 which comprises a predetermined amount of a mixture of sodium hydroxide and aluminum.

In order to accelerate this reaction, mixed metallic iron particles and/or other particles may be added to the heating element 300. In one embodiment of the present invention, a proprietary reactive composition comprises a mixture of aluminum powder, calcium oxide, calcium carbonate, accelerant aid, wetting agent, and/or sodium hydroxide is utilized in a heating element 300. In more specific terms and by way of a nonlimiting example of at least one embodiment of the present invention, the reactive composition may comprise, aluminum at 20%-45% by weight; calcium oxide at 10%-30% by weight; calcium carbonate at 14%-30% by weight; accelerant/potentiator aid at 5%-20% by weight; wetting agent at 5%-20% by weight. In one preferred embodiment, the reactive composition may comprise aluminum at 32%-39% by weight; calcium carbonate at 18%-25% by weight; calcium oxide at 14%-20% by weight; accelerant/potentiator aid at 10%-15% by weight; and a wetting agent at 10%-15% by weight. In one preferred embodiment, at least the aluminum is in a powder form having a particle size of between 320-330 mesh to achieve faster reaction kinetics and higher reactivity. In at least one further embodiment of the present invention, a proprietary reactive composition comprises a mixture of aluminum powder and sodium hydroxide is utilized in the heating element 300. The predetermined amount of aluminum powder and sodium hydroxide is disposed within a fabric pouch or container. In at least one embodiment, the pouch or container 200 is a non-woven fabric, and in one further embodiment, the pouch or container may or may not be biodegradable. As previously noted, the non-woven fabric may be sealed by dual ultrasonic sealing. A heating element 300 in accordance with at least one embodiment of the present invention generates sufficient heat to maintain a temperature within a heating bag 100, and thus, surrounding a food pouch 200, at about 105 degrees Celsius (220 degrees Fahrenheit) for about 3 to about 5 minutes. In one preferred embodiment, the reactive composition in the heating element container achieve an internal temperature with the heating bag 100 of up to 205 degrees Fahrenheit, allowing improved performance across three primary heating modes:
Submersion in heated water
Direct contact heating
Contained hot steam circulation

The proprietary mixture within a heating element 300 in accordance with the present invention may be required to pass the Substances of Very High Concern (SVHC) screening test. In at least one embodiment, a heating element 300 is dimensioned cooperatively with a base 110 of a heating bag 100, in order to facilitate its expansion thereof and to provide stability of the heating bag 100 in a substantially upright position while in use, such as is shown in FIGS. 2 and 3.

A utensils packet 350 in at least one embodiment includes utensils such as plastic or other disposable forks, sporks, knives, napkins, condiments, etc. A utensils packet 350 is removed from the heating bag 100 prior to adding water or another nonflammable aqueous liquid.

According to one embodiment of the invention, a high-efficiency reduced-mass exothermic heater system with enhanced steam management and modular multi-component meal preparation capability is provided. In particular, an aluminum-based exothermic heating composition combined with a heating bag provides for a portable steam-based cooking system, and modular meal solutions enabling rehydration, steaming and cooking of diverse food formats. The heating bag includes a directional steam-vent structure that is configured to circulate steam around food items within the heating bag to more efficiently, effectively and uniformly heat food items in the heating bag. The combined heating bag and directional steam vent structure, along with the reduced-mass aluminum-based exothermic heating composition of the heating element allows for effective heating of food containers such as baby bottles, cans, glass bowls, glass jars, frozen foods, pastries, and food masses up to two pounds. Moreover, the high-efficiency reduced-mass exothermic heater system with enhanced steam management allows for a modular meal preparation system (e.g., OMEALS®) combining retort-based foods with freeze/air-dried components and toppers, as well as seasonings, all reconstituted via high heat from steam circulation. The modular meal preparation system of the present invention allows for a two-step process where a retort-based meal (e.g., in a pouch, bowl or can) is heated for approximately 7-10 minutes, after which seasonings, dried components and freeze-dried toppers can be added and fully reconstituted using the retained heat and steam. This modular meal preparation system thus allows the user to manage the add-ons (i.e., seasonings and toppers) while keeping standardized meal bases, thereby enabling customization for such things as dietary restrictions, cultural preferences, religious diets, and targeted nutritional profiles.

Accordingly, and in summary, one or more embodiments of the present invention comprises a reactive composition contained within and or operably associated with the heating element 300 being reactive with a nonflammable aqueous liquid to initiate an exothermic reaction. The exothermic reaction being sufficient to generate steam within heating bag 100, upon

interaction with the water or other nonflammable aqueous liquid. The heating element 300, the food pouch or other food container 200, and possibly but optionally the utensil pouch 350 and fluid pouch (not shown) initially prepackaged within said heating bag 100 to facilitate ease and efficient storage and transport thereof prior to use.

Further, the heating bag 100 is dimensioned and configured to allow the heating element 300 and the food pouch or other food container 200 to be operatively positioned therein for heating of said food product within the food pouch 200, by the aforementioned generation of steam. The predetermined amount of the reactive composition in the heating element 300 is reactive with the predetermined amount of said nonflammable aqueous liquid to generate sufficient heat to maintain a preferred threshold temperature of about 82 degrees Celsius within the heating bag 100 for about 3 minutes to about 5 minutes, thereby heating the amount of food product in the food pouch or other food container 200 for consumption by a user. The establishment and/or maintenance of the preferred threshold temperature of about 82 degrees Celsius is accomplished and/or facilitated by the at least one steam vent 101 structured and dimensioned to discharge steam from said heating bag 101 at a controlled rate. Such a controlled rate of dispensing the steam from within the interior of the heating bag 100 is sufficient to allow the threshold temperature to be maintained and the attendant heat being sufficient within said heating bag, at about the threshold temperature, by circulating, disposing and/or maintaining the generated steam evenly around the food pouch or other food container 200 to allow for efficient and even heating of said food product and provide a fully heated food product within said food pouch.

The present invention is further directed to a method 1000 for preparing a hot meal for consumption by a user utilizing a self-contained hot meal assembly 400. In at least one embodiment, the present method for preparing a hot meal 1000 comprises opening the resealable opening 102 of a heating bag 100 and removing a food pouch 200 therefrom 1100. In one further embodiment, the present method 1000 also comprises removing a utensils packet 350 from the heating bag 100, when and if a utensil packet 350 is included. The present method for preparing a hot meal 1000 further comprises positioning 1200 a heating element 300, for example, positioning a heating element in a lower portion of the heating bag 100. In accordance with one embodiment, the present method for preparing a hot meal 1000 further comprises placing, as at 1300, a food pouch 200 containing an amount of a food product at least temporarily sealed therein proximate the heating element 300 in the heating bag 100.

The present method for preparing a hot meal 1000 further comprises adding, as at 1400, a predetermined amount of a nonflammable aqueous liquid to the heating bag 100 thereby initiating an exothermic reaction, and the generation of steam, with a reactive composition in the heating element 300. In at least one embodiment, the present method for preparing a hot meal 1000 includes resealing as at 1500 the resealable opening 102 of the heating bag 100. In yet one further embodiment, the present method for preparing a hot meal 1000 further comprises positioning the heating bag 1600, for example, positioning the heating bag 100 in a substantially upright operative orientation and allowing steam generated by the exothermic reaction to heat an amount of food product in the food pouch 200.

The present method for preparing a hot meal 1000 further comprises, as at 1700, the opening the resealable opening 102 of the heating bag 100 and removing a food pouch 200 from the heating bag 100, wherein the food pouch 200 now contains a fully heated food product which is ready to eat.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A self-contained hot meal assembly for heating good contained in one or more food packages comprising:
a heating bag including an access opening and an interior for containing the one or more food packages therein,
said access opening disposed in communicating relation with the interior of said heating bag,
a heating element for placement within the interior of said heating bag and comprising a predetermined amount of a reactive composition contained therein, and said reactive composition having a mass of between 18 grams and 25 grams,
said reactive composition reactive with nonflammable aqueous liquid, added to said heating bag, to initiate an exothermic reaction within said heating bag, said exothermic reaction sufficient to generate steam within said heating bag, upon interaction with said nonflammable aqueous liquid,
said predetermined amount of said reactive composition being reactive with said predetermined amount of nonflammable aqueous liquid to generate sufficient heat, via said generated steam, to maintain a threshold temperature for a predetermined time sufficient to heat said food product for consumption by a user, and
at least one multi-directional steam vent structured and disposed to circulate steam in multiple directions throughout the interior of said heating bag and to discharge the steam from said heating bag at a controlled rate; said controlled rate sufficient to allow said threshold temperature to be maintained within said heating bag by circulating steam evenly around the one or more food packages contained within the interior of said heating bag to provide a fully heated food product.

2. The self-contained hot meal assembly as recited in claim 1 wherein said reactive composition comprises aluminum, calcium oxide, calcium carbonate, an accelerant/potentiator aid and a wetting agent.

3. The self-contained hot meal assembly as recited in claim 2 wherein aluminum is present in the reactive composition in an amount of between 20%-40% by weight of the composition.

4. The self-contained hot meal assembly as recited in claim 3 wherein calcium oxide is present in the reactive composition in an amount of between 10%-30% by weight of the composition.

5. The self-contained hot meal assembly as recited in claim 3 wherein calcium carbonate is present in the reactive composition in an amount of between 14%-30% by weight of the composition.

6. The self-contained hot meal assembly as recited in claim 3 wherein the accelerator/potentiator aid is present in the reactive composition in an amount of between 5%-20% by weight of the composition.

7. The self-contained hot meal assembly as recited in claim 3 wherein the wetting agent is present in the reactive composition in an amount of between 5%-20% by weight of the composition.

8. The self-contained hot meal assembly as recited in claim 2 wherein the aluminum is in a powder form having a particle size of between 320-330 mesh.

9. The self-contained hot meal assembly as recited in claim 1 wherein the assembly, including the heating bag and the heating element are structured for modular meal preparation combining retort-based foods and freeze/air-dried components and toppers and seasonings, for heating within the heating bag.

10. The self-contained hot meal assembly as recited in claim 1 wherein the food packages containing food for heating within the interior of the heating bag include baby bottles, metal cans, glass bowls, glass jars, frozen food packages and retort pouches.
